(19) United States
(12) Patent Application Publication
(10) Pub. No.: US 2024/0128445 A1
(43) Pub. Date: Apr. 18, 2024

(54) ELECTRODE PIECE, BATTERY CELL AND BATTERY

(71) Applicant: Zhuhai CosMX Power Battery CO., LTD., Zhuhai (CN)

(72) Inventors: Chengpeng LAI, Zhuhai (CN); Kaiming YU, Zhuhai (CN); Lingling JIN, Zhuhai (CN); Hongguang SHEN, Zhuhai (CN); Meili WANG, Zhuhai (CN)

(21) Appl. No.: 18/530,104

(22) Filed: Dec. 5, 2023

Related U.S. Application Data
(63) Continuation of application No. PCT/CN2022/131786, filed on Nov. 14, 2022.

(30) Foreign Application Priority Data
Dec. 13, 2021 (CN) 2021115197328

(51) Int. Cl. H01M 4/36; H01M 4/62; H01M 10/052

(52) U.S. Cl. CPC H01M 4/366; H01M 4/623; H01M 10/052; H01M 2004/021

(57) ABSTRACT

Embodiments of the present application provide an electrode piece, a battery cell and a battery, where the electrode piece includes a current collector, a first material layer, and an active material layer; the first material layer and the active material layer are provided on a surface of the current collector, and the first material layer and the active material layer extend along a length direction of the current collector and are alternately arranged in a width direction of the current collector; where the first material layer includes a first material, and the first material includes an amphiphilic polymer and a structural conductive polymer. The infiltration effect of the electrolyte can be improved, the aging time is shortened, and an injection amount of electrolyte is reduced.

### CROSS-REFERENCE TO RELATED APPLICATION

This application is a continuation of International Application No. PCT/CN2022/131786, filed on Nov. 14, 2022, which claims priority to Chinese Patent Application No. 202111519732.8, filed on Dec. 13, 2021. Both of the aforementioned applications are hereby incorporated by reference in their entireties.

### TECHNICAL FIELD

The present disclosure relates to the technical field of batteries, in particular to an electrode piece, battery cell, and battery.

### BACKGROUND

Lithium-ion batteries have been widely used in various fields such as digital products and electric tools due to their advantages such as high capacity, long lifespan and no memory. With the increase in production capacity of lithium-ion batteries, raw material prices are also gradually rising.

In the preparation process of the lithium-ion batteries, an electrolyte needs to be injected into the batteries. During the aging process, the electrolyte can infiltrate into the electrode piece and participate in chemical reactions, achieving the conversion of chemical energy to electrical energy. At present, in order to improve the infiltration effect of the electrolyte and thereby improve the cycling performance of lithium-ion batteries, it is usually necessary to inject a large amount of electrolyte during the injection process, which makes the cost of lithium-ion batteries high.

### SUMMARY

In view of the above problems, the embodiments of the present application provide an electrode piece, battery cell and battery, which aims at improving the wettability of the electrolyte and reducing the amount of electrolyte, thereby shortening the battery aging time and improving the cycling performance of the lithium battery.

In order to achieve the above object, in a first aspect, an embodiment of the present application provides an electrode piece, including a current collector, a first material layer and an active material layer, where the first material layer and the active material layer are provided on a surface of the current collector, and the first material layer and the active material layer extend along a length direction of the current collector and are alternately arranged in a width direction of the current collector.

Where the first material layer includes a first material, and the first material includes an amphiphilic polymer and a structural conductive polymer.

In an embodiment, there are at least three first material layers and at least two active material layers.

In an embodiment, a thickness of the first material layer is smaller than a thickness of the active material layer.

In an embodiment, the thickness of the first material layer is 5 μm to 40 μm; and/or, a difference between the thickness of the active material layer and the thickness of the first material layer is greater than or equal to 40 μm.

In an embodiment, a width of the first material layer ranges from 2 mm to 6 mm.

In an embodiment, the amphiphilic polymer includes a polyvinylidene fluoride (PVDF), the PVDF is formed by compounding a C—C or C—F main bond with a hydrophilic group; the hydrophilic group includes at least one of sodium carboxymethyl cellulose (CMC), magnesium methacrylate, acrylic acid, methacrylic acid, maleic acid, tetrahydrophthalic acid, zinc methacrylate, and zinc acrylate.

In an embodiment, the structural conductive polymer includes at least one of polyether sulfone (PES), polyvinyl pyrrolidone (PVP), polyethylene glycol (PEG), polypyrrole, polyphenylene sulfide, polyphthalocyanine compounds, polyaniline, and polythiophene.

In an embodiment, a mass proportion of the amphiphilic polymer in the first material ranges from 60% to 70%; and/or, a mass proportion of the structural conductive polymer in the first material is 5% to 25%.

In a second aspect, an embodiment of the application provides a battery cell, which includes a positive electrode piece and a negative electrode piece, where the positive electrode piece and/or the negative electrode piece are the electrode piece provided in the first aspect.

In a third aspect, an embodiment of the application provides a battery, which includes the battery cell provided in the second aspect.

In the embodiments of the application, the first material layer includes a first material, and the first material includes an amphiphilic polymer and a structural conductive polymer. Amphiphilic polymer has amphiphilicity and structural conductive polymer has strong conductivity, this enables the amphiphilic polymer to undergo a chain of nucleophilic reactions under the stimulation of the electrolyte after injection of the electrolyte, enhancing the hydrophilicity, and thus the injected electrolyte can be quickly absorbed through the first material layer and transferred into the electrode piece, accelerating the infiltration of the electrolyte into the electrode piece. Under the premise of achieving the same infiltration effect, this can greatly reduce a use amount of the electrolyte and save a material cost of preparation of the battery. Moreover, with the improved infiltration of the electrolyte, the aging time of the battery can be effectively shortened, shortening the overall process of battery preparation.

### BRIEF DESCRIPTION OF DRAWINGS

FIG. 1 is a top view of a positive electrode piece of the present application.

FIG. 2 is a top view of a negative electrode piece of the present application.

FIG. 3 is a top view of a current collector of the present application.

FIG. 4 is a cross-sectional view of a positive electrode piece of the present application.

FIG. 5 is a cross-sectional view of a negative electrode piece of the present application.

FIG. 6 is a top view of a positive electrode piece after die-cutting according to the present application.

FIG. 7 is a top view of a negative electrode piece after die-cutting according to the present application.

### DESCRIPTION OF REFERENCE SIGNS

10—current collector; 11—tab; 20—first material layer; 30—active material layer.

### DESCRIPTION OF EMBODIMENTS

It should be understood that the specific embodiments described herein are only used to explain the present application and are not intended to limit it.

The following clearly and comprehensively describes the technical solutions in embodiments of the present application with reference to the accompanying drawings in embodiments of the present application. Apparently, the described embodiments are merely part of embodiments the present application rather than all of the embodiments. All other embodiments obtained by persons of ordinary skill in the art based on the embodiments of the present application without creative effort shall fall within the protection scope of the present application.

It should be noted that all directional indications (such as up, down, left, right, front, rear . . . ) in the embodiments of the application are only used to explain the relative position relationship, motion situation, etc. among components in a certain specific posture (as shown in the attached figures). If the specific posture changes, the directional indication also changes accordingly.

In addition, the descriptions related to “first”, “second”, etc. in the present application are only for descriptive purpose and cannot be understood as indicating or implying their relative importance or implicitly indicating the number of indicated technical features. Therefore, a feature limited by “first” or “second” can explicitly or implicitly include at least one such feature. In addition, the technical solutions of the embodiments can be combined with each other, but they must be based on the realization by persons of ordinary skill in the art, and when a combination of technical solutions is contradictory or impossible, it should be considered that the combination of the technical solutions does not exist and is not within the scope of protection of the present application.

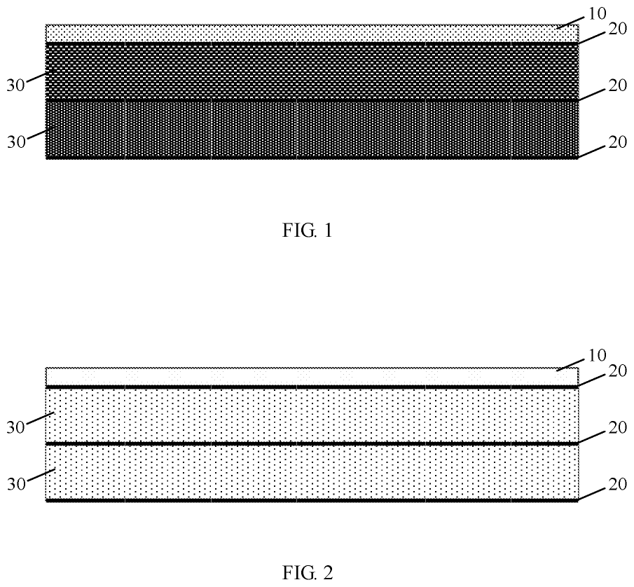

Referring to FIGS. 1 to 7, embodiments of the present application provide an electrode piece.

The electrode piece includes a current collector 10, a first material layer 20, and an active material layer 30; the first material layer 20 and the active material layer 30 are provided on a surface of the current collector 10, and the first material layer 20 and the active material layer 30 extend along a length direction of the current collector 10 and are alternately arranged in a width direction of the current collector 10; wherein the first material layer 20 includes a first material, and the first material includes an amphiphilic polymer and a structural conductive polymer.

In the embodiments of the present application, the strip-shaped first material layers 20 are arranged at interval on a surface of the current collector 10. Due to the fact that materials of the first material layer 20 include an amphiphilic polymer and a structural conductive polymer, where the amphiphilic polymer has amphiphilicity and the structural conductive polymer has strong conductivity, the amphiphilic polymer undergoes a chain of nucleophilic reactions under stimulation of the electrolyte after electrolyte injection, enhancing the hydrophilicity and thus the injected electrolyte can be quickly absorbed and transferred into the electrode piece, accelerating the infiltration of the electrolyte into the electrode piece. In other words, the infiltration effect of the electrode piece is improved by improving the infiltration of the electrolyte. Under the premise of achieving the same infiltration effect, the use amount of the electrolyte can be greatly reduced, saving the material cost of battery preparation. Moreover, with the improved infiltration of the electrolyte, the aging time of the battery can be effectively shortened, and the efficiency of aging and standing can also be improved, shortening the overall process of battery preparation.

In addition, because the amphiphilic polymer has hydrophilicity and strong hydrophobicity, the baking of the battery cell before electrolyte injection can accelerate the evaporation of water inside the electrode piece through the first material layer 20. The baking time of the battery cell can be effectively shortened, further shortening the overall preparation process of the battery.

It should be noted that both the positive and negative electrode pieces can adopt the electrode piece structure provided in the embodiments of the application. In the case where the electrode piece is a positive electrode piece, as shown in FIG. 1, the active material layer 30 includes a positive electrode active material, and in an embodiment, the positive electrode active material includes but is not limited to one or more of lithium cobaltate, lithium manganate, lithium nickelate, lithium nickel manganese cobaltate, lithium nickel manganese cobalt aluminate, lithium nickel cobaltate and lithium-rich manganese, and the current collector 10 can be an aluminum foil. In the case where the electrode piece is a negative electrode piece, as shown in FIG. 2, the active material layer 30 includes a negative electrode active material, and in an embodiment, the negative electrode active material includes but is not limited to one or more of lithium titanate, lithium powder, aluminum powder, metal oxide, artificial graphite, natural graphite, silicon, silicon alloy, sulfur, sulfur alloy and silicon carbon, and the current collector 10 can be a copper foil. Specifically, it may be decided according to the actual situation, and the embodiments of the present application have no limitation on this.

In an embodiment, the electrode piece includes at least three first material layers 20 and at least two active material layers 30.

In this embodiment, it may be that multiple first material layers 20 are evenly spaced between the active material layers 30, so that the infiltration of the electrolyte is more uniform, further improving the infiltration effect of the electrode piece.

Taking as an example the electrode piece including three first material layers 20 and two active material layers 30, the positive electrode piece can be shown in FIG. 1, and the negative electrode piece can be shown in FIG. 2. The three first material layers 20 and the two active material layers 30 are alternately arranged on a surface of the current collector 10, and the surface of the current collector 10 in a width direction thereof has a side edge area that can be an empty foil area for setting a tab. In the width direction, one first material layer 20, one active material layer 30, one first material layer 20, one active material layer 30 and one first material layer 20 are sequentially arranged from the empty foil area towards a direction away from the empty foil area.

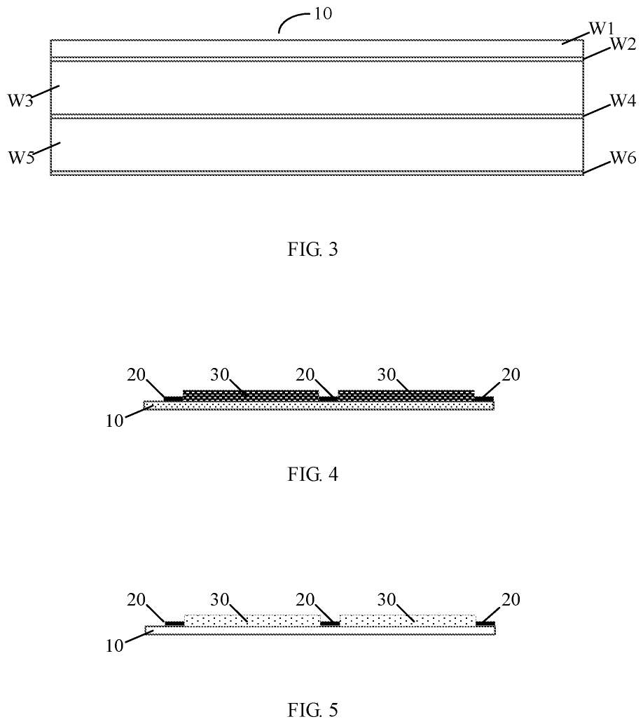

During a specific coating process, as shown in FIG. 3, six areas W1, W2, W3, W4, W5 and W6 can be pre-divided on the surface of the current collector 10, then a slurry of the first material layer 20 can be applied to three areas W2, W4, and W6, and a slurry of the active material layer 30 can be applied to two areas W3 and W5.

In an embodiment, a thickness of the first material layer 20 is smaller than a thickness of the active material layer 30.

In this embodiment, as shown in FIGS. 4 and 5, the thickness of the first material layer 20 is smaller than the thickness of the active material layer 30. Therefore, a concave space is formed in the first material layer 20. The concave space can not only increase a contact area between the electrolyte and the active material layer 30 during electrolyte infiltration, further improving the infiltration effect of the electrode piece, but also increase a remaining space of residual electrolyte after losing the electrolyte, so that under the premise of the same battery cell size, it is able to adsorb and store more electrolyte for supplementation in subsequent battery charging and discharging process, thereby improving the cycling life of the battery.

In an embodiment, the thickness of the first material layer 20 is 5 μm to 40 μm.

In an embodiment, a difference between the thickness of the active material layer 30 and the thickness of the first material layer 20 is greater than or equal to 40 μm. That is to say, the first material layer 20 is at least 40 μm thinner than the active material layer 30.

In an embodiment, a width of the first material layer 20 ranges from 2 mm to 6 mm.

In an embodiment, the amphiphilic polymer includes a PVDF, the PVDF is formed by compounding a C—C or C—F main bond with a hydrophilic group; the hydrophilic group includes at least one of sodium CMC, magnesium methacrylate, acrylic acid, methacrylic acid, maleic acid, tetrahydrophthalic acid, zinc methacrylate and zinc acrylate.

In this embodiment, it is necessary to bake the battery cell before injecting the electrolyte into the battery. Chain links —CH2- and —CF2- in the PVDF have a low critical surface energy and strong hydrophobicity. When baking the battery cell, water inside the electrode piece can be accelerated to evaporate out through the first material layer 20, thereby shortening the baking time. After electrolyte injection, the PVDF can remove HF on its surface under acidic action, to form a double bond or a triple bond, and can react with a nucleophilic reagent under the stimulation of the electrolyte to generate a large number of hydroxyl groups, the hydroxyl groups can further react to generate other groups. Through this chain nucleophilic reaction, the layered structure of the PVDF is modified, the critical surface energy is enhanced, and the hydrophilicity is also strengthened, so that the electrolyte can be rapidly transferred to the interior of the electrode piece through the first material layer 20, accelerating the infiltration of the electrolyte, thereby shortening the aging time and improving the aging efficiency.

In an embodiment, a mass proportion of the amphiphilic polymer in the first material ranges from 60% to 70%.

In an embodiment, a particle size of the amphiphilic polymer ranges from 10 nm to 100 nm.

In an embodiment, the structural conductive polymer includes at least one of PES, PVP, PEG, polypyrrole, polyphenylene sulfide, polyphthalocyanine compounds, polyaniline, and polythiophene.

In an embodiment, a mass proportion of the structural conductive polymer in the first material is 5% to 25%.

In an embodiment, a particle size of the structural conductive polymer ranges from 10 nm to 250 nm.

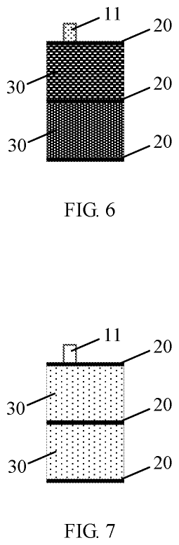

It should be noted that if the battery cell is a laminated battery cell, the electrode pieces shown in FIGS. 1 and 2 need to be cut before they are applied to the laminated battery cell, the cut positive electrode piece can be as shown in FIG. 6, and also includes a die-cut tab 11, the cut positive electrode piece can be as shown in FIG. 7, and also includes a die-cut tab 11.

An embodiment of the application also provides a battery cell.

The battery cell includes a positive electrode piece and a negative electrode piece, and the positive electrode piece and/or the negative electrode piece are the electrode pieces provided in the embodiments of the present application.

It should be noted that in this embodiment, the battery cell includes all the technical features of the electrode piece provided by the above embodiments, and can achieve all the beneficial effects that can be achieved by the electrode piece in the above embodiments. Details can be found in the explanation of the above embodiments and will not be repeated here.

An embodiment of the present application also provides a battery.

The battery includes the battery cell provided in the embodiment of the present application.

It should be noted that in this embodiment, the battery cell includes all the technical features of the electrode piece provided by the above embodiments, and can achieve all the beneficial effects that can be achieved by the electrode piece in the above embodiments. Details can be found in the explanation of the above embodiments and will not be repeated here.

The following is to describe a preparation method of the battery provided in the embodiment of the present application:

Step 1: Preparation of functional slurry

In this step, the functional slurry is a slurry of the first material layer 20. Specifically, an amphiphilic polymer, a structural conductive polymer and a conductive agent are prepared into a functional slurry in a certain mass ratio. In an embodiment, the functional slurry is a composite slurry formed by mixing the amphiphilic polymer, the structural conductive polymer, and a conductive carbon black in a ratio of 50-60:40-30:1-10. In the functional slurry, the amphiphilic polymer and the structural conductive polymer have a mass proportion of 30% to 60%, and a particle size of 10 nm to 400 nm.

Further, the amphiphilic polymer includes a PVDF, the PVDF is formed by a C—C or C—F main bond and a hydrophilic group. The hydrophilic group includes at least one of sodium CMC, magnesium methacrylate, acrylic acid, methacrylic acid, maleic acid, tetrahydrophthalic acid, zinc methacrylate, and zinc acrylate. The amphiphilic polymer has a mass proportion of 60% to 70%, and a particle size of 10 nm to 100 nm.

Furthermore, the structural conductive polymer includes at least one of PES, PVP, PEG, polypyrrole, polyphenylene sulfide, polyphthalocyanine compounds, polyaniline, and polythiophene, the structural conductive polymer has a mass proportion of 5% to 25%, and a particle size of 10 nm to 250 nm.

Step 2: Preparation of positive electrode piece

In this step, the functional slurry prepared in step 1 is coated onto the three areas W2, W4 and W6, as shown in FIG. 3, of a positive electrode current collector, and then dried. Afterwards, a positive electrode active material, a conductive agent, and an adhesive are prepared to a positive electrode active slurry in a certain mass ratio, the positive electrode slurry is then coated onto two areas W3 and W5 of the positive electrode current collector as shown in FIG. 3, than dried and rolled to obtain a positive electrode piece.

Step 3: Preparation of negative electrode piece

In this step, the functional slurry prepared in step 1 is coated onto the three areas W2, W4, and W6, as shown in FIG. 3, of a negative electrode current collector, and then dried. Afterwards, a negative electrode active material, an adhesive, a thickener and a conductive agent are mixed and dispersed in deionized water to obtain a uniformly dispersed negative electrode active slurry. The negative electrode active slurry is then applied to the two areas W3 and W5, as shown in FIG. 3, of the negative electrode current collector, then dried and rolled to obtain a negative electrode piece.

Step 4: Preparation of battery cell and packaging of battery

In this step, the positive electrode piece prepared in step 2 and the negative electrode piece prepared in step 3 are combined with a diaphragm to form a bare battery cell, then, it is packaged by an aluminum plastic film, baked, injected with an electrolyte, aged, formed, secondary packaged, and sorted to form a battery.

The following are nine specific examples of the present application and one comparative example.

### EXAMPLE 1

### Step 1: Preparation of Positive Electrode Piece

1) 96.7 parts of ternary materials (lithium nickel cobalt manganate) NCM523, 2.2 parts of conductive agent, and 1.1 parts of N-methyl pyrrolidone are dispersed by stirring to obtain a positive electrode active slurry of the active material layer 30 of the positive electrode piece.

2) 60% of PVDF, 20% of PES, 10% of PEG and 10% of conductive carbon black are dispersed by stirring in a stirring tank to obtain a functional slurry of the first material layer 20 of the positive electrode piece.

3) the functional slurry prepared in step 2) is applied to W2, W4 and W6 areas as shown in FIG. 3 of an aluminum foil by an extrusion coater, and then dried. Then, the positive active electrode slurry prepared in step 1) is applied to W3 and W5 areas as shown in FIG. 3 of an aluminum foil, and then dried and rolled to obtain a positive electrode piece. Where the thicknesses of W2, W4 and W6 areas are 5 μm and the widths thereof are 2 mm; the thicknesses of W3 and W5 areas are 5 μm; the coating speed is 5 m/min, and the rolling speed is 10 m/min to 15 m/min.

### Step 2: Preparation of Negative Electrode Piece

1) 96.6 parts of graphite as negative electrode active material, 2 parts of a conductive agent, 1.0 parts of adhesive, and 0.4 parts of CMC as thickener are mixed and dissolved in deionized water and dispersed by stirring to obtain a negative electrode active slurry of the active material layer 30 of the negative electrode piece.

2) 60% of PVDF, 20% of PVP, 10% of sodium CMC, and 10% of conductive carbon black are dispersed by stirring in a stirring tank to obtain a functional slurry of the first material layer 20 of the negative electrode piece.

3) the functional slurry prepared in step 2) is applied to W2, W4 and W6 areas as shown in FIG. 3 of a copper foil by an extrusion coater, and then is dried. Then, the negative electrode active slurry prepared in step 1) is applied to W3 and W5 areas as shown in FIG. 3 of a copper foil, and then dried and rolled to obtain a negative electrode piece. Where the thicknesses of W2, W4 and W6 areas (thicknesses of the first material layers) are 5 μm and the widths thereof are 2 mm; the thicknesses of W3 and W5 areas (thicknesses of the active material layers) are 83 μm; the coating speed is 5 m/min, and the rolling speed is 10 m/min to 15 m/min.

### Step 3: Preparation of Battery Cell and Packaging of Battery

In this step, the positive electrode piece prepared in step 1 and the negative electrode piece prepared in step 2 are die-cut and laminated together with a diaphragm to form a laminated battery cell, which is then packaged by an aluminum plastic film, injected with an electrolyte, aged, formed, secondary packaged, and sorted to form a battery, being marked as group SY1.

### EXAMPLE 2

The difference between this example and Example 1 is that the thicknesses of the first material layers 20 of the positive electrode piece and the negative electrode piece are 20 μm and the widths thereof are 4 mm, being marked as group SY2.

### EXAMPLE 3

The difference between this example and Example 1 is that the thicknesses of the first material layers 20 of the positive electrode piece and the negative electrode piece are 40 μm and the widths thereof are 6 mm, being marked as group SY3.

### EXAMPLE 4

The difference between this example and Example 1 is that the thicknesses of the first material layers 20 of the positive electrode piece and the negative electrode piece are 20 μm and the widths thereof are 2 mm, being marked as group SY4.

### EXAMPLE 5

The difference between this example and Example 1 is that the thicknesses of the first material layers 20 of the positive electrode piece and the negative electrode piece are 40 μm and the widths thereof are 4 mm, being marked as group SY5.

### EXAMPLE 6

The difference between this example and Example 1 is that in Step 1, 50% of polyvinylidene fluoride (PVDF), 30% of polyether sulfone (PES), 10% of polyethylene glycol (PEG) are dispersed by stirring in a stirring tank to obtain a functional slurry of the first material layer 20 of the positive electrode plate, being marked as group SY6.

### EXAMPLE 7

The difference between this example and Example 1 is that 50% of PVDF, 40% of PVP, 5% of sodium CMC and 5% of conductive carbon black are dispersed by stirring in a stirring tank to obtain a functional slurry of the first material layer 20 of the negative electrode piece, being marked as group SY7.

### EXAMPLE 8

The difference between this example and Example 1 is that the thicknesses of the first material layers 20 of the positive electrode piece and the negative electrode piece are 50 μm and the widths thereof are 2 mm, being marked as group SY8.

### EXAMPLE 9

The difference between this example and Example 1 is that the thicknesses of the first material layers 20 of the positive electrode piece and the negative electrode piece are 60 μm and the widths thereof are 2 mm, being marked as group SY9.

### COMPARATIVE EXAMPLE 1

### Step 1: Preparation of Positive Electrode Piece

1) 96.7 parts of ternary materials (lithium nickel cobalt manganate) NCM523, 2.2 parts of conductive agent, and 1.1 parts of N-methyl pyrrolidone are dispersed by stirring to obtain a positive electrode active slurry of the positive electrode piece.

2) the positive electrode active slurry prepared in step 1) is applied to an aluminum foil by an extrusion coater, and then dried and rolled to obtain a positive electrode piece. Wherein, the coating speed is 5 m/min, and the rolling speed is 10 m/min to 15 m/min.

### Step 2: Preparation of Negative Electrode Piece

1) 96.6 parts of graphite as negative electrode active material, 2 parts of conductive agent, 1.0 parts of adhesive, and 0.4 parts of thickener CMC are mixed and dissolved in deionized water and dispersed by stirring to obtain a negative electrode active slurry of the negative electrode piece.

2) the negative electrode active slurry prepared in step 1) is applied to a copper foil by an extrusion coater, and then dried and rolled to obtain a negative electrode piece. Wherein, the coating speed is 5 m/min, and the rolling speed is 10 m/min to 15 m/min.

### Step 3: Preparation of Battery Cell and Packaging of Battery

In this step, the positive electrode piece prepared in step 1 and the negative electrode piece prepared in step 2 are die-cut and laminated together with a diaphragm to form a laminated battery cell, which is then packaged by an aluminum plastic film, baked, injected with an electrolyte, aged, formed, secondary packaged, and sorted to form a battery, being marked as group DB1.

In the process of preparing the batteries SY1-SY9 obtained in Examples 1-9 and the battery DB1 obtained in Comparative Example 1, process data of each battery group is recorded, where the process data includes the baking time before electrolyte injection and the aging time after electrolyte injection. Where, the aging time refers to an aging time when the battery cell reaches a qualified infiltration of electrode piece at room temperature under the premise of the same battery cell size, and determination of whether infiltration of the electrode piece is qualified can be based on whether each layer of electrode piece is evenly infiltrated by electrolyte after the battery cell is disassembled. Specific process data is shown in Table 1.

TABLE l
Process data of batteries in groups SY1-SY9 and DB1

| Group | SY1 | SY2 | SY3 | SY4 | SY5 | SY6 | SY7 | SY8 | SY9 | DB1 |
|---|---|---|---|---|---|---|---|---|---|---|
| Baking time (h ) | 6 | 5 | 4 | 4 | 4 | 6 | 10 | 16 | 22 | 26 |
| Aging time (h) | 4 | 6 | 4 | 4 | 4 | 4 | 8 | 15 | 20 | 24 |

It can be seen from Table 1, the aging time of DB1 battery prepared by a conventional method is 24 h after electrolyte injection, and the aging time of SY1-SY9 batteries can basically be kept below 8 H after electrolyte injection. Generally, the aging time of conventionally prepared batteries after electrolyte injection is 24 h to 48 h. After a number of tests, the aging time of batteries provided by the embodiments of the present application can be shortened to 4 h to 12 h, which is roughly shortened by 25% or more, and correspondingly, amount of the injected electrolyte can be reduced by 10% to 20%, saving the cost of electrolyte by 5% to 20%; in addition, the baking time before electrolyte injection is also shortened by 25% or more, and the efficiencies of the batteries of the present application are improved by 25% or more respectively.

The batteries SY1-SY9 obtained in Examples 1-9 and the battery DB1 obtained in Comparative Example 1 are subjected to long-term cycle tests. Where, a method of long-term cycle test specifically includes:
1) charge to 4.2V and discharge to 3.0V;
2) charging current 5 C, cut off at 0.5 C;
3) discharge current 8 C and cut-off voltage 3.0V.

According to the above steps, at the temperature of 25° C.+/−3° C., the charge and discharge cycle tests are carried out, and the battery cell voltage, capacity and appearance are monitored during the test process. Specific monitoring data is shown in Table 2.

TABLE 2
Long-term cycle monitoring data of
batteries in groups SY1-SY9 and DB1

| Group | SY1 | SY2 | SY3 | SY4 | SY5 | SY6 | SY7 | SY8 | SY9 | DB1 |
|---|---|---|---|---|---|---|---|---|---|---|
| Cycle times | 2800 | 2800 | 3000 | 3000 | 2800 | 2800 | 2500 | 2300 | 2100 | 2000 |

It can be seen from Table 2, the cycle times of the batteries provided by the examples of the present application are significantly improved.

The above are only exemplary examples of the present application and do not limit the scope of the present application, any equivalent structure or equivalent process transformation made by using the contents of specification and drawings of the present application, or direct or indirect application thereof in other related technical fields, are equally included in the protection scope of the present application.

What is claimed is:

1. An electrode piece, comprising a current collector, a first material layer and an active material layer, wherein
the first material layer and the active material layer are provided on a surface of the current collector, and the first material layer and the active material layer extend along a length direction of the current collector and are alternately arranged in a width direction of the current collector;
wherein the first material layer comprises a first material, and the first material comprises an amphiphilic polymer and a structural conductive polymer,
wherein functional slurry is a slurry of the first material layer, and particle sizes of the amphiphilic polymer and the structural conductive polymer are 10 nm to 400 nm.

2. The electrode piece according to claim 1, wherein there are at least three first material layers and at least two active material layers.

3. The electrode piece according to claim 1, wherein a thickness of the first material layer is smaller than a thickness of the active material layer.

4. The electrode piece according to claim 1, wherein a thickness of the first material layer is 5 μm to 40 μm; and/or, a difference between a thickness of the active material layer and a thickness of the first material layer is greater than or equal to 40 μm.

5. The electrode piece according to claim 1, wherein a width of the first material layer is 2 mm to 6 mm.

6. The electrode piece according to claim 1, wherein the amphiphilic polymer comprises a polyvinylidene fluoride (PVDF), the polyvinylidene fluoride (PVDF) is formed by compounding a C—C or C—F main bond with a hydrophilic group; the hydrophilic group comprises at least one of sodium carboxymethyl cellulose (CMC), magnesium methacrylate, acrylic acid, methacrylic acid, maleic acid, tetrahydrophthalic acid, zinc methacrylate, and zinc acrylate.

7. The electrode piece according to claim 1, wherein the structural conductive polymer comprises at least one of polyether sulfone (PES), polyvinyl pyrrolidone (PVP), polyethylene glycol (PEG), polypyrrole, polyphenylene sulfide, polyphthalocyanine compounds, polyaniline, and polythiophene.

8. The electrode piece according to claim 1, wherein a mass proportion of the amphiphilic polymer in the first material ranges from 60% to 70%; and/or, a mass proportion of the structural conductive polymer in the first material is 5% to 25%.

9. A battery cell, comprising a positive electrode piece and a negative electrode piece, wherein the positive electrode piece and/or the negative electrode piece are the electrode pieces according to claim 1.

10. The battery cell according to claim 9, wherein there are at least three first material layers and at least two active material layers.

11. The battery cell according to claim 9, wherein a thickness of the first material layer is smaller than a thickness of the active material layer.

12. The battery cell according to claim 9, wherein a thickness of the first material layer is 5 μm to 40 μm; and/or, a difference between a thickness of the active material layer and a thickness of the first material layer is greater than or equal to 40 μm.

13. The battery cell according to claim 9, wherein a width of the first material layer is 2 mm to 6 mm.

14. The battery cell according to claim 9, wherein the amphiphilic polymer comprises a polyvinylidene fluoride (PVDF), the polyvinylidene fluoride (PVDF) is formed by compounding a C—C or C—F main bond with a hydrophilic group; the hydrophilic group comprises at least one of sodium carboxymethyl cellulose (CMC), magnesium methacrylate, acrylic acid, methacrylic acid, maleic acid, tetrahydrophthalic acid, zinc methacrylate, and zinc acrylate.

15. The battery cell according to claim 9, wherein the structural conductive polymer comprises at least one of polyether sulfone (PES), polyvinyl pyrrolidone (PVP), polyethylene glycol (PEG), polypyrrole, polyphenylene sulfide, polyphthalocyanine compounds, polyaniline, and polythiophene.

16. The battery cell according to claim 9, wherein a mass proportion of the amphiphilic polymer in the first material ranges from 60% to 70%; and/or, a mass proportion of the structural conductive polymer in the first material is 5% to 25%.

17. A battery, comprising the battery cell according to claim 9.

18. The battery according to claim 17, wherein there are at least three first material layers and at least two active material layers.

19. The battery according to claim 17, wherein a thickness of the first material layer is smaller than a thickness of the active material layer.

20. The battery according to claim 17, wherein a thickness of the first material layer is 5 μm to 40 μm; and/or, a difference between a thickness of the active material layer and a thickness of the first material layer is greater than or equal to 40 μm.
